(19) United States
(12) Patent Application Publication
(10) Pub. No.: US 2025/0224661 A1
(43) Pub. Date: Jul. 10, 2025

(54) PROJECTION APPARATUS CAPABLE OF BEING BUILT INTO INFLATABLE PRODUCT

(71) Applicant: Lifeideas co., Ltd, Jiangmen City (CN)

(72) Inventor: Juan Cao, Jiangmen City (CN)

(73) Assignee: Lifeideas co., Ltd, Jiangmen City (CN)

(21) Appl. No.: 19/091,813

(22) Filed: Mar. 26, 2025

(30) Foreign Application Priority Data
Feb. 25, 2025 (CN) 2025102161129

(51) Int. Cl. G03B 21/585; G03B 21/00; G03B 21/14

(52) U.S. Cl. CPC G03B 21/585; G03B 21/006; G03B 21/142; G03B 21/145

(57) ABSTRACT

A projection apparatus capable of being built into an inflatable product is provided and includes an inflatable cloth sleeve. A projection device and an audio playback device are fixedly connected inside the inflatable cloth sleeve, an imaging space is arranged between a front end of the projection device and the inflatable cloth sleeve, and the projection device and the audio playback device are wirelessly connected with an intelligent terminal. By combining the projection device with the inflatable cloth sleeve, the projection device has a larger imaging distance and a wider imaging range, and video pictures are dynamically displayed on the surface of the inflatable cloth sleeve, thus improving the display effect of the inflatable cloth sleeve. The projection device has a variety of installation and connection methods, which can meet different installation requirements, and can also play recordings or audio through the audio playback device, further improving interactive effect.

### CROSS-REFERENCE TO RELATED APPLICATIONS

This application claims priority of Chinese Patent Application No. 2025102161129 filed on Feb. 25, 2025, the content of which is hereby incorporated by reference.

### TECHNICAL FIELD

The disclosure relates to the technical field of projection apparatus, in particular to a projection apparatus capable of being built into an inflatable product.

### BACKGROUND

At present, many occasions, such as toys, holiday products, outdoor decorative products, etc., adopt inflatable structures, but the existing inflatable products can only be visually designed and expressed in appearance, or lighting is added to improve the display effect, and the visual dynamic effect is poor.

In order to make inflatable products have better visual expression effect and stronger playability, if various videos and patterns can be displayed more vividly on the surface of inflatable products, the display effect of inflatable products will be obviously improved.

Therefore, there is an urgent need for a projection apparatus that can be built into an inflatable product, which can effectively achieve the above functions and effects.

### SUMMARY

An object of the disclosure is to provide a projection apparatus capable of being built into an inflatable product, so as to solve the problems existing in the prior art.

In order to achieve the above objectives, the disclosure provides the following scheme:
a projection apparatus capable of being built into an inflatable product is provided, and includes an inflatable cloth sleeve, where a projection device and an audio playback device are fixedly connected inside the inflatable cloth sleeve, an imaging space is arranged between a front end of the projection device and the inflatable cloth sleeve, and the projection device and the audio playback device are wirelessly connected with an intelligent terminal.

Preferably, the inflatable cloth sleeve is provided with an air charging and discharging port, and the air charging and discharging port is externally connected with a direct current blower.

Preferably, the inflatable cloth sleeve adopts a cartoon shaped structure.

Preferably, the projection device includes a shell, a mounting seat is arranged outside the shell, a heat sink, a built-in fan, a main control system IC, a grating generator, a video screen and an imaging lens are sequentially arranged in the shell from back to front, a temperature control switch is arranged on the heat sink, and the main control system IC is externally connected with a power line.

Preferably, the video screen adopts an LCD screen.

Preferably, the imaging lens is provided with a focal length adjusting assembly.

Preferably, the projection device is provided with control buttons, an infrared remote sensing module, a Bluetooth module, a WiFi module and an APP module.

Preferably, the mounting seat is arranged at a rear end of the shell, and an edge of the mounting seat is connected with the inflatable cloth sleeve through a snap button.

Preferably, the mounting seat is arranged in a middle of the shell, and an edge of the mounting seat is connected with the inflatable cloth sleeve through a snap button.

Preferably, a middle of the inflatable cloth sleeve is suspended with a mounting plate, the mounting seat is arranged at a bottom of the shell, and an edge of the mounting seat is connected with the mounting plate through a snap button.

Compared with the prior art, the disclosure has the following beneficial technical effects.

The disclosure provides the projection apparatus capable of being built into an inflatable product, including the inflatable cloth sleeve, where a projection device and an audio playback device are fixedly connected in the inflatable cloth sleeve, an imaging space is arranged between a front end of the projection device and the inflatable cloth sleeve, and the projection device and the audio playback device are wirelessly connected with an intelligent terminal. By combining the projection device with the inflatable cloth sleeve, the projection device has a larger imaging distance and a wider imaging range, and video pictures are dynamically displayed on the surface of the inflatable cloth sleeve, thus improving the display effect of the inflatable cloth sleeve. At the same time, the projection device has a variety of installation and connection methods, which can meet different installation requirements, and can also play recordings or audio through the audio playback device, further improving the interactive effect.

### BRIEF DESCRIPTION OF THE DRAWINGS

In order to more clearly explain the technical scheme in the embodiment of the disclosure or in the prior art, the drawings needed in the embodiment will be briefly introduced below. Obviously, the drawings in the following description are only some embodiments of the disclosure, and other drawings can be obtained according to these drawings without creative labor for ordinary skilled in the field.

FIG. 1 is a schematic diagram of the external structure of a projection apparatus capable of being built into an inflatable product according to the disclosure;

FIG. 2 is a schematic structural diagram of a projection device in the projection apparatus capable of being built into an inflatable product according to the disclosure;

FIG. 3 is a schematic diagram of the installation mode of Embodiment 1 in the projection apparatus capable of being built into an inflatable product according to the disclosure;

FIG. 4 is a schematic diagram of the installation mode of Embodiment 2 in the projection apparatus capable of being built into an inflatable product according to the disclosure;

FIG. 5 is a schematic diagram of the installation mode of Embodiment 3 in the projection apparatus capable of being built into an inflatable product according to the disclosure;

FIG. 6A is a circuit diagram of a serial port according to the embodiment of the disclosure;

FIG. 6B is a circuit diagram of a TF card signal network according to the embodiment of the disclosure

FIG. 6C is control circuit diagram of a TF card according to the embodiment of the disclosure;

FIG. 6D is a power supply circuit diagram of a TF card according to the embodiment of the disclosure;

FIG. 6E is a control circuit diagram of a key according to the embodiment of the disclosure;

FIG. 6F is a circuit diagram of a USB interface according to the embodiment of the disclosure;

FIG. 6G is a circuit diagram of a USB socket according to the embodiment of the disclosure

FIG. 7A is a circuit diagram of an audio output according to the embodiment of the disclosure;

FIG. 7B is a power supply circuit diagram of the power amplifier according to the embodiment of the disclosure;

FIG. 7C is a control circuit diagram of power amplifier according to the embodiment of the disclosure;

FIG. 7D is a schematic diagram of the connection mode of an audio output signal according to the embodiment of the disclosure;

FIG. 8A is a 1.15V voltage step-down circuit diagram according to the embodiment of the disclosure;

FIG. 8B is a 1.5V voltage step-down circuit diagram according to the embodiment of the disclosure;

FIG. 8C is a 3.3V voltage step-down circuit diagram according to the embodiment of the disclosure;

FIG. 8D is a 5V voltage step-down circuit diagram according to the embodiment of the disclosure;

FIG. 8E is a circuit diagram of a fan control switch according to the embodiment of the disclosure;

FIG. 8F is a control circuit diagram of the LED according to the embodiment of the disclosure;

FIG. 9 is a main control circuit diagram of the projection apparatus capable of being built into an inflatable product according to the disclosure; and

FIG. 10 is a circuit diagram of a temperature control switch of the projection apparatus capable of being built into an inflatable product according to the disclosure.

### DETAILED DESCRIPTION OF THE EMBODIMENTS

In the following, the technical scheme in the embodiment of the disclosure will be described clearly and completely with reference to the attached drawings in the embodiment of the disclosure. Obviously, the described embodiment is only a part of the embodiment of the disclosure, but not all of the embodiments. Based on the embodiments in the disclosure, all other embodiments obtained by ordinary skilled in the field without creative efforts belong to the scope of protection of the disclosure.

It is an object of the disclosure to provide a projection apparatus capable of being built into an inflatable product to solve the problems existing in the prior art.

In order to make the above objects, features and advantages of the disclosure more obvious and easy to understand, the disclosure will be further described in detail with the attached drawings and specific embodiments.

### Embodiment 1

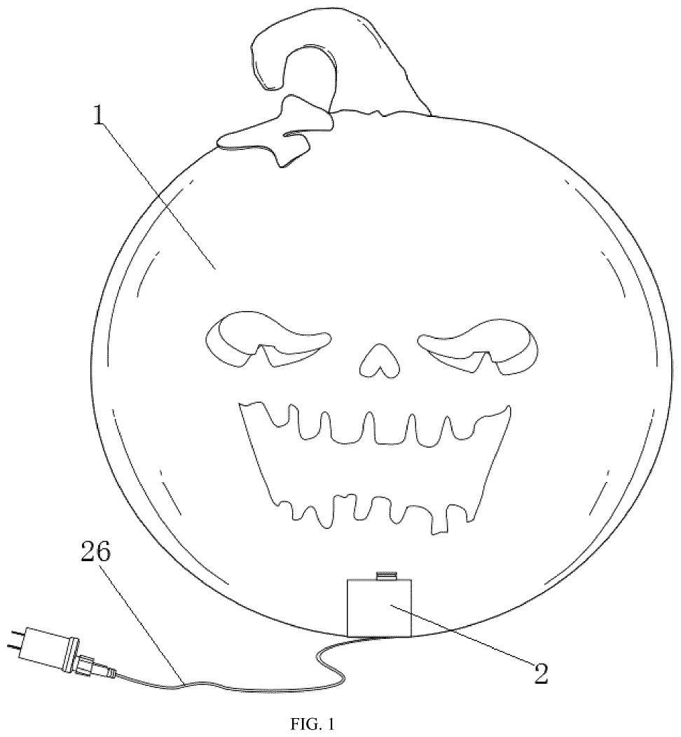

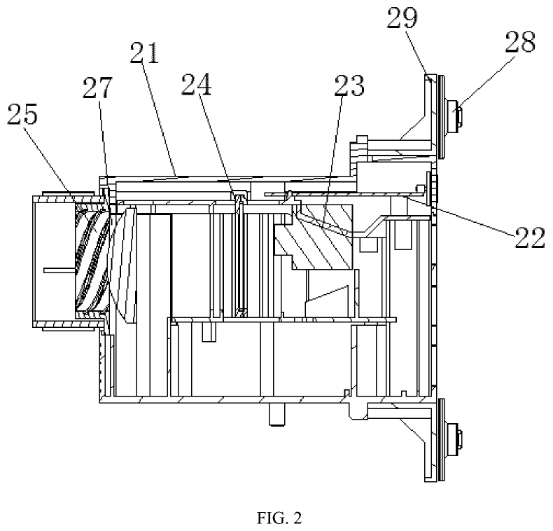

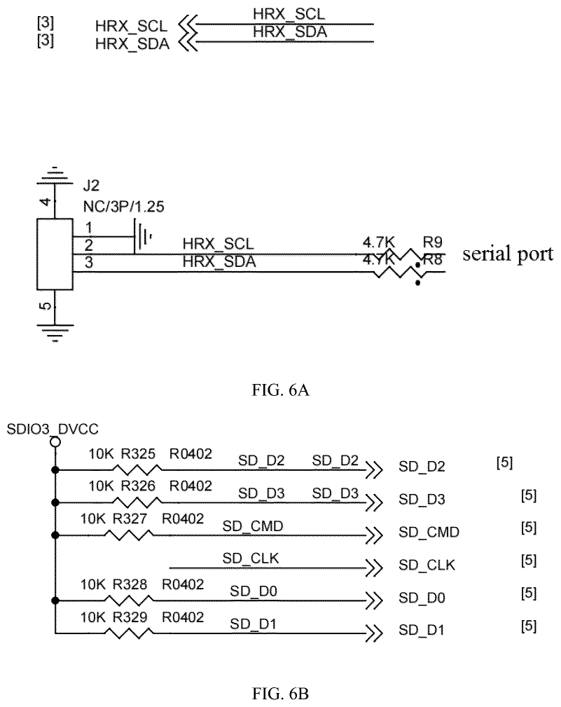

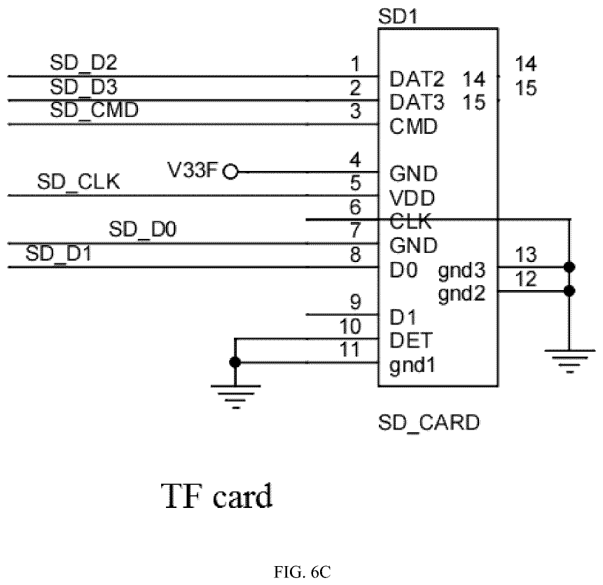

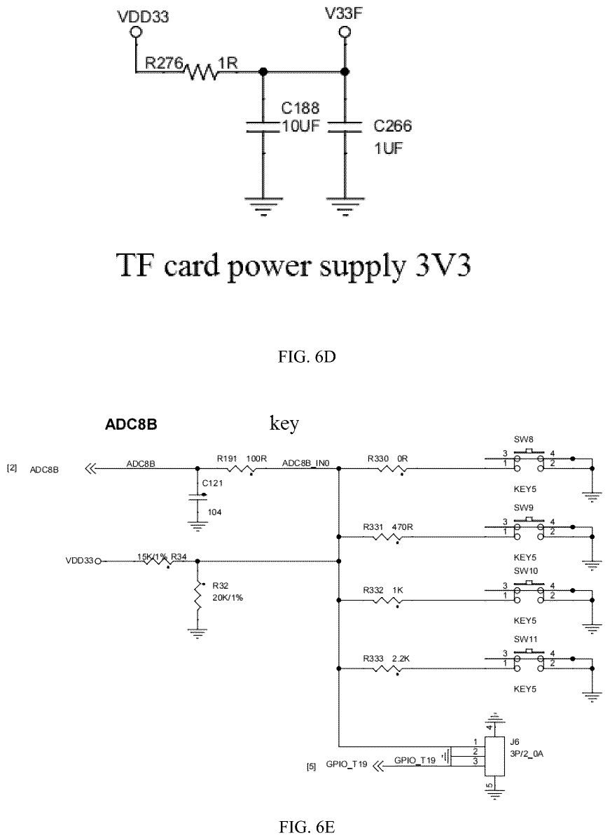

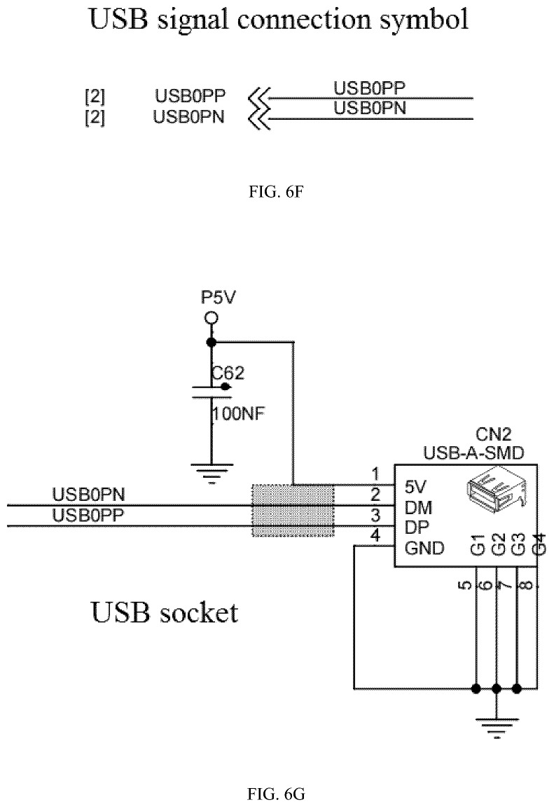

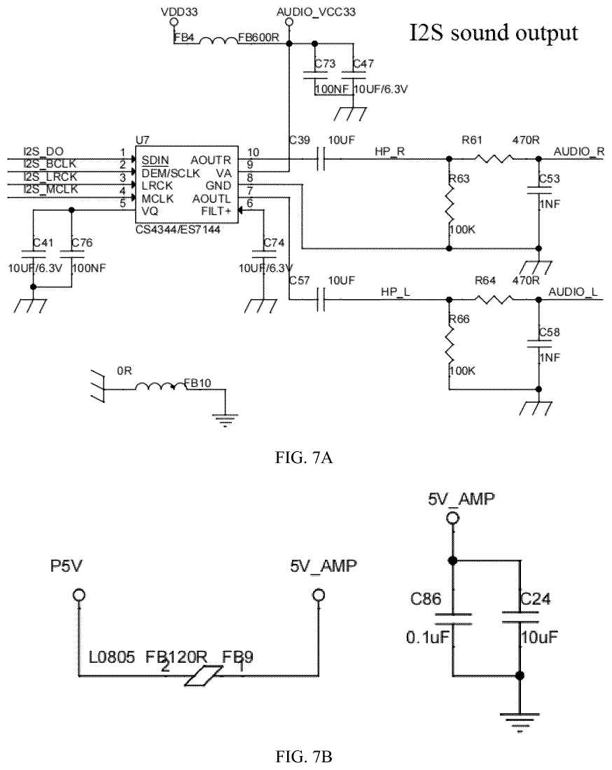

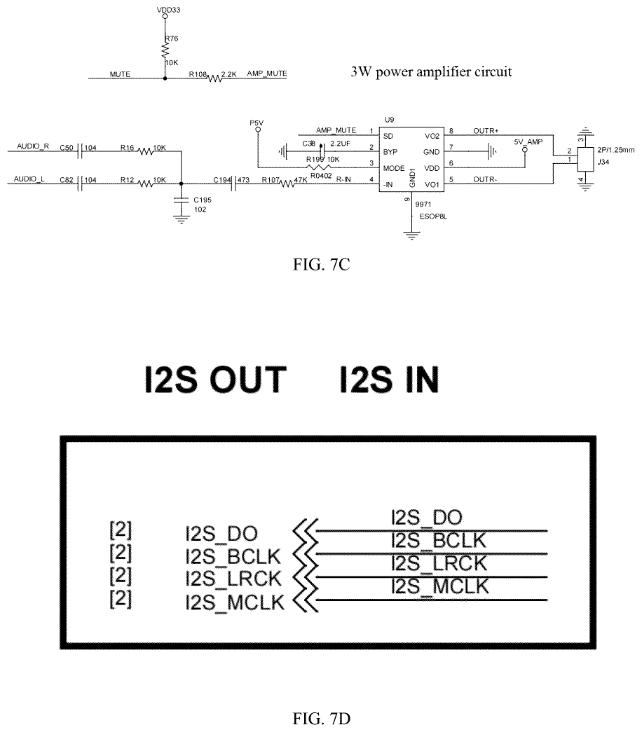

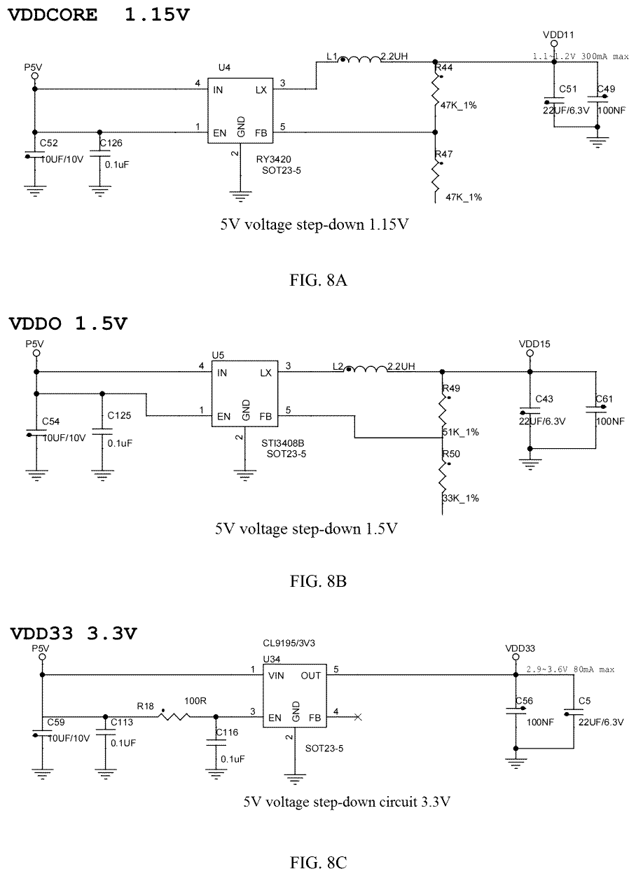

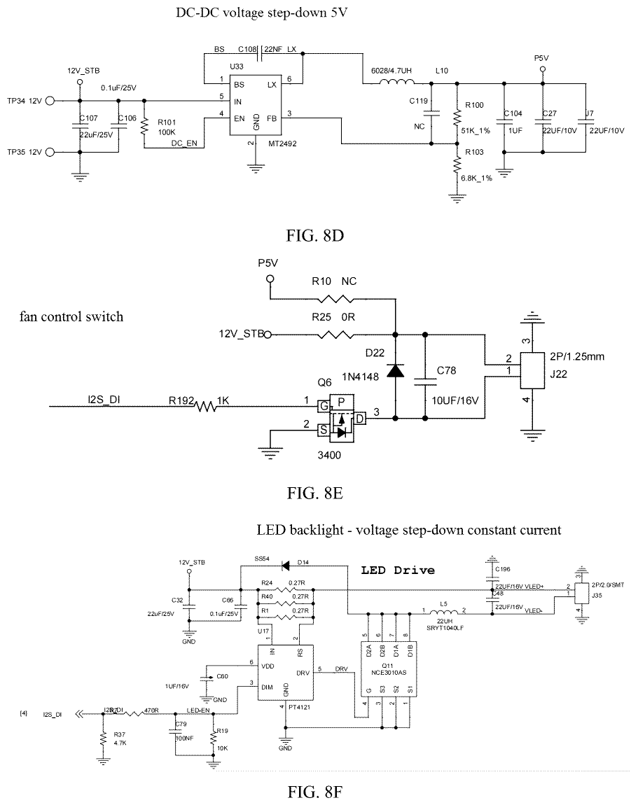

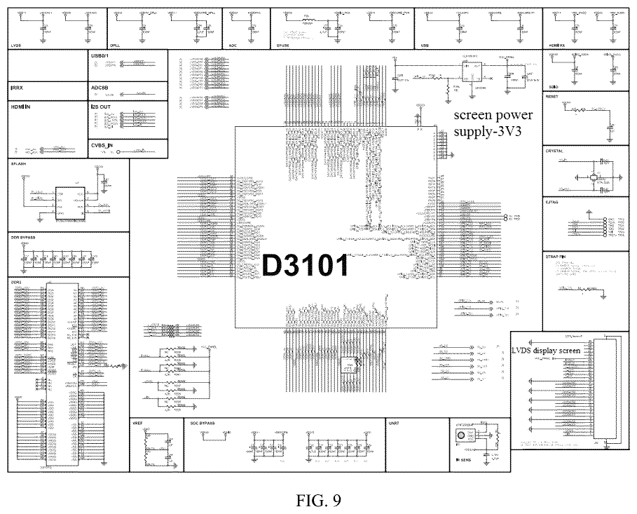

This embodiment provides a projection apparatus capable of being built into an inflatable product. As shown in FIGS. 1-3, 6A-6G, 7A-7D, 8A-8F, and 9, an inflatable cloth sleeve 1 is included. A projection device 2 and an audio playback device are fixedly connected inside the inflatable cloth sleeve 1. An imaging space is provided between a front end of the projection device 2 and the inflatable cloth sleeve 1, and the projection device 2 and the audio playback device are wirelessly connected with an intelligent terminal.

As an embodiment, the audio playback device at least includes a control panel, a speaker, a microphone, an audio playback module, and a Bluetooth module. When in use, audio can be recorded through the microphone or sent through the intelligent terminal, and processed by the audio playback module, for example, the recorded or uploaded audio is played through the speaker after sound change, speed adjustment and noise reduction, so as to improve the interactive display effect.

As an embodiment, the inflatable cloth sleeve 1 is provided with an air charging and discharging port, and the inflatable cloth sleeve can be inflated by connecting an air pump, and the air charging and discharging port is externally connected with a direct current blower, so as to avoid or reduce air leakage and keep the inflatable state for a long time.

As an embodiment, the inflatable cloth sleeve 1 adopts a cartoon shaped structure. In this embodiment, the inflatable cloth sleeve 1 adopts a pumpkin shape. Of course, cartoon shapes such as cartoon characters can also be adopted in other embodiments.

As an embodiment, the projection device 2 includes a shell 21, and a mounting seat 29 is arranged outside the shell 21; a heat sink, a built-in fan, a main control system IC 22, a grating generator 23, a video screen 24 and an imaging lens 25 are sequentially arranged in the shell 21 from back to front. The main control system IC 22 is externally connected with a power line 26; after power is connected, the main control system IC 22 controls the grating generator 23 to generate a grating. After passing through the shielded video screen 24 and the imaging lens 25, the video or image is projected in front, so that the surface of the cloth sleeve has an image display effect, and the built-in fan can quickly transfer the heat generated by the light source to the heat sink, so as to be discharged to the outside, and the projection device is prevented from overheating.

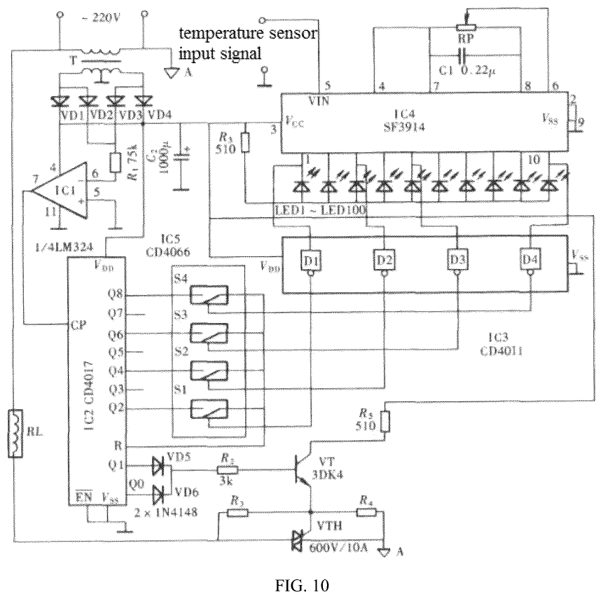

As an embodiment, as shown in FIG. 10, the heat sink is provided with a temperature control switch, which can control the power off of the light source when the temperature is higher than 85° C., so as to avoid apparatus damage or fire caused by overheating, and resume power supply after the temperature drops to 65° C., so that the projection device 2 can operate stably and safely.

As an embodiment, the video screen 24 is an LCD screen.

As an embodiment, the imaging lens 25 is provided with a focal length adjusting assembly 27, so that it is convenient to adjust the focal length to make the picture clear.

As an embodiment, the projection device 2 can not only play video images, but also be used as a light, and jump and flash by emitting polychromatic light, thus improving the display effect.

As an embodiment, the projection device 2 is provided with control buttons, which can be controlled when the control buttons are exposed. Of course, if the projection device 2 is completely hidden in the inflatable cloth sleeve 1, the infrared remote sensing module, Bluetooth module, WiFi module and APP module can be used for remote control or networking control, and when Bluetooth is used for connection control, the user can talk or play remotely through the mobile phone, thus effectively improving the functionality.

As an embodiment, a plurality of projection devices in different inflatable products can also be interconnected to realize linkage effect, and the control module of one projection device controls other projection devices to alternately transform or cooperate with each other to realize interactive animation effect, and the interactive forms include sound and animation video. For example, one of the pumpkin inflatable models sings or makes an expression animation, and the next three doll inflatable models will sing or make an echo expression, thus realizing an interactive linkage scene.

As an embodiment, the mounting seat 29 is arranged at a rear end of the shell 21, and the edge of the mounting seat 29 is connected with the inflatable cloth sleeve 1 through the snap button 28, so as to realize the stable connection between the mounting seat and the inflatable cloth sleeve.

### Embodiment 2

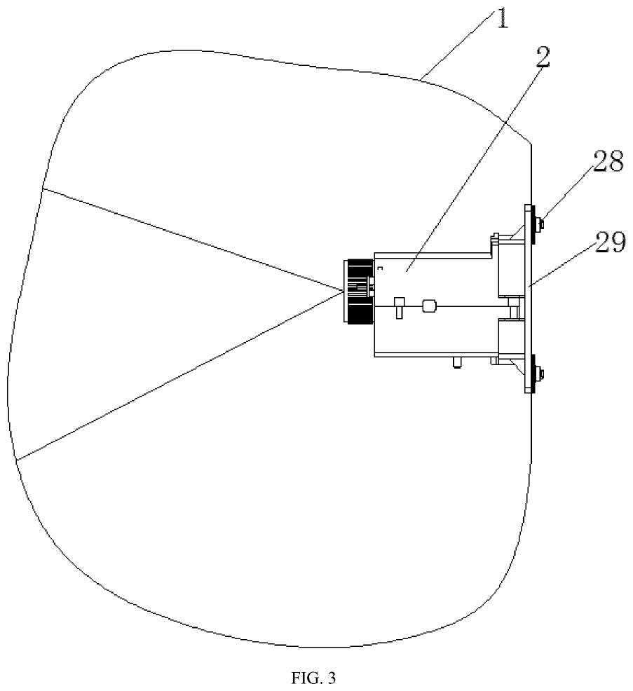

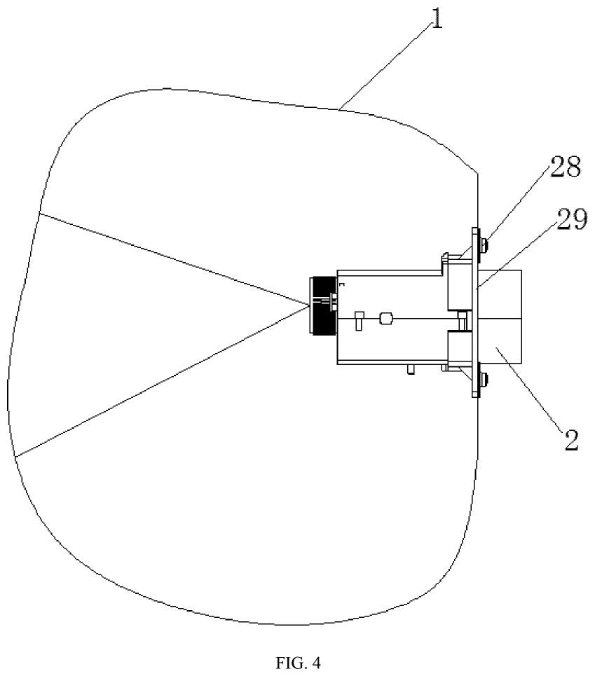

As a variation of Embodiment 1, this embodiment provides a brand-new installation mode. As shown in FIG. 4, the mounting seat 29 is arranged in the middle of the shell 21, and the edge of the mounting seat 29 is connected with the inflatable cloth sleeve 1 through the snap button 28, so that the rear end of the shell 21 can be exposed to the outside, and it is convenient to install components such as interfaces and buttons.

Except that the above installation mode is different from that of Embodiment 1, the other structures and principles are the same as those of Embodiment 1.

### Embodiment 3

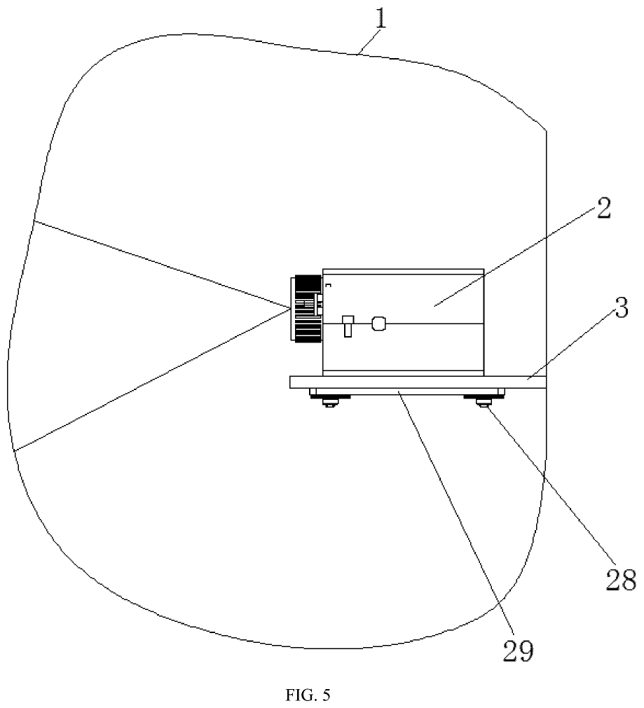

As a variation of Embodiment 1, this embodiment provides a brand-new installation mode. As shown in FIG. 5, the mounting plate 3 is suspended in the middle of the inflatable cloth sleeve 1, which can be integrally arranged with the inflatable cloth sleeve 1 or independently connected. The mounting seat 29 is arranged at the bottom of the shell 21, and the edge of the mounting seat 29 is connected with the mounting plate 3 through the snap button 28, so that the projection device 2 can be installed in the middle of the inflatable cloth sleeve 1.

It should be noted that since the mounting plate 3 is suspended, it is inevitable that the mounting plate 3 will be inclined after the projection device 2 is installed. At this time, the projection device 2 can be cushioned by setting an inclined cushion block, thus ensuring its good projection effect.

Except that the above installation mode is different from that of Embodiment 1, the other structures and principles are the same as those of Embodiment 1.

The disclosure provides the projection apparatus capable of being built into an inflatable product. By combining the projection device with the inflatable cloth sleeve, the projection device has a larger imaging distance and a wider imaging range, and the video picture is dynamically displayed on the surface of the inflatable cloth sleeve, thus improving the display effect of the inflatable cloth sleeve. At the same time, the projection device has various installation and connection modes, which can meet different installation requirements.

The principle and implementation of the disclosure are explained by specific examples, and the description of the above embodiments is only used to help understand the method and core idea of the disclosure. At the same time, for ordinary skilled in this field, according to the idea of the disclosure, there will be changes in the specific implementation and application scope. In summary, the contents of this description should not be construed as limiting the disclosure.

What is claimed is:

1. A projection apparatus capable of being built into an inflatable product, comprising an inflatable cloth sleeve, wherein a projection device and an audio playback device are fixedly connected inside the inflatable cloth sleeve, an imaging space is arranged between a front end of the projection device and the inflatable cloth sleeve, and the projection device and the audio playback device are wirelessly connected with an intelligent terminal.

2. The projection apparatus capable of being built into an inflatable product according to claim 1, wherein the inflatable cloth sleeve is provided with an air charging and discharging port, and the air charging and discharging port is externally connected with a direct current blower.

3. The projection apparatus capable of being built into an inflatable product according to claim 1, wherein the inflatable cloth sleeve adopts a cartoon shaped structure.

4. The projection apparatus capable of being built into an inflatable product according to claim 1, wherein the projection device comprises a shell, a mounting seat is arranged outside the shell, a heat sink, a built-in fan, a main control system IC, a grating generator, a video screen and an imaging lens are sequentially arranged in the shell from back to front, a temperature control switch is arranged on the heat sink, and the main control system IC is externally connected with a power line.

5. The projection apparatus capable of being built into an inflatable product according to claim 4, wherein the video screen adopts an LCD screen.

6. The projection apparatus capable of being built into an inflatable product according to claim 4, wherein the imaging lens is provided with a focal length adjusting assembly.

7. The projection apparatus capable of being built into an inflatable product according to claim 4, wherein the projection device is provided with control buttons, an infrared remote sensing module, a Bluetooth module, a WiFi module and an APP module.

8. The projection apparatus capable of being built into an inflatable product according to claim 4, wherein the mounting seat is arranged at a rear end of the shell, and an edge of the mounting seat is connected with the inflatable cloth sleeve through a snap button.

9. The projection apparatus capable of being built into an inflatable product according to claim 4, wherein the mounting seat is arranged in a middle of the shell, and an edge of the mounting seat is connected with the inflatable cloth sleeve through a snap button.

10. The projection apparatus capable of being built into an inflatable product according to claim 4, wherein a middle of the inflatable cloth sleeve is suspended with a mounting plate, the mounting seat is arranged at a bottom of the shell, and an edge of the mounting seat is connected with the mounting plate through a snap button.
